(19) United States
(12) Patent Application Publication
(10) Pub. No.: US 2024/0330799 A1
(43) Pub. Date: Oct. 3, 2024

(54) VISUAL DISPLAY FOR OVERLAPPING INTERVALS

(71) Applicant: Kinaxis Inc., Ottawa (CA)

(72) Inventors: Ivy BLACKMORE, Ottawa (CA); David Christopher DEWAR, Ottawa (CA)

(21) Appl. No.: 18/610,780

(22) Filed: Mar. 20, 2024

Related U.S. Application Data
(60) Provisional application No. 63/492,321, filed on Mar. 27, 2023.
(60) Provisional application No. 63/503,072, filed on May 18, 2023.

(51) Int. Cl. G06Q 10/0631; G06T 11/20

(52) U.S. Cl. CPC G06Q 10/063114; G06T 11/206; G06T 2210/62

(57) ABSTRACT

Systems and methods for a visual display of overlapping intervals, that comprise a visual display of one or more overlapping entities, wherein a timeline of each entity is displayed with a respective directional, translucent shape.

This application claims priority of U.S. Ser. No. 63/492,321 filed Mar. 27, 2023, and of U.S. Ser. No. 63/503,072 filed May 18, 2023, the disclosure of each of which is hereby incorporated by reference in its respective entirety.

### BACKGROUND

Visually displaying the length of entities is something many software solutions do—from online calendars to project planning suites. Swimlanes can become unwieldy and large, as more items are added to each swimlane. There is thus a need to make the overall chart more compact. However, the more densely populated or compressed these displays become, the harder it becomes to show multiple overlapping entities. With very little space to display multiple overlapping entities, visually determining where one entity ends and the next entity begins becomes difficult or impossible. The entities can be ordered items-such as dates, timelines, numbers, integers and the like.

### BRIEF SUMMARY

Disclosed herein are systems and methods that can illustrate overlapping intervals of entities by representing each entity with a directional, translucent shape. The directional shapes do not reduce legibility, while at the same time, they may make it easy to differentiate the start of one entity from an end of a different overlapping entity. This enables readers, even at a glance, to view multiple overlapped entities without confusing the respective start and end point of each entity. Furthermore, these systems and methods allow for an illustration that is compact.

For example, the entities can be ordered dates, timelines, numbers, integers, and the like. As an example, overlapping timeline intervals can be displayed by representing events using directional, translucent shapes.

In one aspect, a computer-implemented method is provided, which includes receiving, by a processor, input data having one or more start parameters and one or more end parameters. The computer-implemented method also includes identifying, by the processor, a minimum value and a maximum value to define a range of a visualization axis. The computer-implemented method also includes rendering, by the processor, a visualization parameter axis from a smallest parameter to a largest parameter. The computer-implemented method also includes identifying, by the processor, one or more groups of data; for each group of data: identifying, by the processor, a set of start data parameters and a set of end data parameters; adding, by the processor, a row or a column to a visualization; for each start data parameter and each end data parameter, rendering, by the processor, a directional shape from start to end along the visualization parameter axis, the directional shape being translucent.

In the computer-implemented method, the input data may be ordered. Where the input data is ordered, the input data is one of a date, a time, a date time, a number, or an integer. Furthermore, the input data may include a parameter for grouping one or more sets of start parameters and end parameters. In addition, the minimum value may be equal to a smallest start parameter value, and the maximum value may be equal to a largest end parameter value. The computer-implemented method may also provide for a visual display of overlapping timeline intervals, and the method may include visually displaying, by the processor, one or more overlapping events, where a timeline of each event is displayed with a respective directional shape. Other technical features may be readily apparent to one skilled in the art from the following figures, descriptions, and claims.

In one aspect, a computing apparatus is provided which includes a processor. The computing apparatus also includes a memory storing instructions that, when executed by the processor, configure the apparatus to receive input data having one or more start parameters and one or more end parameters. The computing apparatus also includes a memory storing instructions that, when executed by the processor, configure the apparatus to identify a minimum value and a maximum value to define a range of a visualization axis. The computing apparatus also includes a memory storing instructions that, when executed by the processor, configure the apparatus to render a visualization parameter axis from a smallest parameter to a largest parameter. The computing apparatus also includes a memory storing instructions that, when executed by the processor, configure the apparatus to identify one or more groups of data; for each group of data, the apparatus is configured to: identify a set of start data parameters and a set of end data parameters; add a row or a column to a visualization; and for each start data parameter and each end data parameter, render a directional shape from start to end along the visualization parameter axis, the directional shape being translucent.

In the computing apparatus, the input data may be ordered. Where the input data is ordered, the input data is one of a date, a time, a date time, a number, or an integer. Furthermore, the input data may include a parameter for grouping one or more sets of start parameters and end parameters. In addition, the minimum value may be equal to a smallest start parameter value, and the maximum value may be equal to a largest end parameter value. The computing apparatus may also provide a visual display of overlapping timeline intervals, and the instructions that, when executed by the processor, configure the apparatus to: visually display one or more overlapping events, where a timeline of each event is displayed with a respective directional shape. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive, input data having one or more start parameters and one or more end parameters; identify a minimum value and a maximum value to define a range of a visualization axis; render a visualization parameter axis from a smallest parameter to a largest parameter; identify one or more groups of data; and for each group of data: identify a set of start data parameters and a set of end data parameters; add a row or a column to a visualization; and for each start data parameter and each end data parameter: render a directional shape from start to end along the visualization parameter axis, the directional shape being translucent.

In the computer-readable storage medium, the input data may be ordered. Where the input data is ordered, the input data is one of a date, a time, a date time, a number, or an integer. Furthermore, the input data may include a parameter for grouping one or more sets of start parameters and end parameters. In addition, the minimum value may be equal to a smallest start parameter value, and the maximum value may be equal to a largest end parameter value. The computer-readable storage medium may also provide a visual display of overlapping timeline intervals, and the instructions that when executed by a computer, cause the computer to visually display one or more overlapping events, where a timeline of each event is displayed with a respective directional shape. Other technical features may be readily apparent to one skilled in the art from the following figures, descriptions, and claims.

In one aspect, a computer-implemented method is provided, which includes receiving, by a processor, input data having one or more start parameters and one or more end parameters, the input data including one or more parameters that define elements in a legend. The computer-implemented method also includes identifying, by the processor, a minimum value and a maximum value to define a range of a visualization axis. The computer-implemented method also includes rendering, by the processor, a visualization parameter axis from a smallest parameter to a largest parameter. The computer-implemented method also includes identifying, by the processor, one or more groups of data; for each group of data: identifying, by the processor, a set of start data parameters and a set of end data parameters; adding, by the processor, a row or a column to a visualization; for each start data parameter and each end data parameter: setting, by the processor, a property for a directional shape for the legend; rendering, by the processor, the directional shape from start to end along the visualization parameter axis, the directional shape being translucent; and rendering, by the processor, a visualization legend.

In the computer-implemented method, the input data may be ordered. Where the input data is order, the input data may be one of a date, a time, a date time, a number, or an integer. Furthermore, the input data may include a parameter for grouping one or more sets of start parameters and end parameters. In addition, the minimum value may be equal to a smallest start parameter value, and the maximum value may be equal to a largest end parameter value. The computer-implemented method may be for a visual display of overlapping timeline intervals, and the method may include visually displaying, by the processor, one or more overlapping events, where a timeline of each event is displayed with a respective directional shape. Other technical features may be readily apparent to one skilled in the art from the following figures, descriptions, and claims.

In one aspect, a computing apparatus is provided, which includes a processor. The computing apparatus also includes a memory storing instructions that, when executed by the processor, configure the apparatus to receive input data having one or more start parameters and one or more end parameters, the input data including one or more parameters that define elements in a legend. The computing apparatus also includes a memory storing instructions that, when executed by the processor, configure the apparatus to identify a minimum value and a maximum value to define a range of a visualization axis. The computing apparatus also includes a memory storing instructions that, when executed by the processor, configure the apparatus to render a visualization parameter axis from a smallest parameter to a largest parameter. The computing apparatus also includes a memory storing instructions that, when executed by the processor, configure the apparatus to identify one or more groups of data; for each group of data: identify a set of start data parameters and a set of end data parameters; add a row or a column to a visualization; for each start data parameter and each end data parameter, set a property for a directional shape for the legend; and render the directional shape from start to end along the visualization parameter axis, the directional shape being translucent, and render a visualization legend.

In the computing apparatus, the input data may be ordered. Where the input data is order, the input data may be one of a date, a time, a date time, a number, or an integer. Furthermore, the input data may include a parameter for grouping one or more sets of start parameters and end parameters. In addition, the minimum value may be equal to a smallest start parameter value, and the maximum value may be equal to a largest end parameter value. The computing apparatus may also be configured for a visual display of overlapping timeline intervals, and the apparatus may be configured to visually display one or more overlapping events, where a timeline of each event is displayed with a respective directional shape. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to receive input data having one or more start parameters and one or more end parameters, the input data including one or more parameters that define elements in a legend. The non-transitory computer-readable storage medium also includes instructions that when executed by the computer, cause the computer to: identify a minimum value and a maximum value to define a range of a visualization axis. The non-transitory computer-readable storage medium also includes instructions that when executed by the computer, cause the computer to render a visualization parameter axis from a smallest parameter to a largest parameter. The non-transitory computer-readable storage medium also includes instructions that when executed by the computer, cause the computer to identify one or more groups of data; for each group of data, the instructions that when executed by the computer, cause the computer to: identify a set of start data parameters and a set of end data parameters; add a row or a column to a visualization. For each start data parameter and each end data parameter, the computer-readable storage medium including instructions that when executed by the computer, cause the computer to: set a property for a directional shape for the legend; render the directional shape from start to end along the visualization parameter axis, the directional shape being translucent; and render a visualization legend.

In computer-readable storage medium, the input data may be ordered. Where the input data is order, the input data may be one of a date, a time, a date time, a number, or an integer.

Furthermore, the input data may include a parameter for grouping one or more sets of start parameters and end parameters. In addition, the minimum value may be equal to a smallest start parameter value, and the maximum value may be equal to a largest end parameter value. The computer-readable storage medium may also instructions that when executed by the computer, configure the computer for a visual display of overlapping timeline intervals, and furthermore, the instructions that when executed by the computer, cause the computer to visually display one or more overlapping events, where a timeline of each event is displayed with a respective directional shape. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for a visual display of overlapping timeline intervals in accordance with one embodiment.

FIG. 2 illustrates a roadmap with conventional swimlanes.

FIG. 3 illustrates a conventional Gantt chart.

FIG. 4 illustrates an example of overlapping timelines.

FIG. 5 illustrates an aspect of the subject matter in accordance with one embodiment.

FIG. 6 illustrates an aspect of the subject matter in accordance with one embodiment.

FIG. 7 illustrates a block diagram in accordance with one embodiment.

FIG. 8 illustrates a block diagram in accordance with one embodiment.

FIG. 9 illustrates a system architecture diagram in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

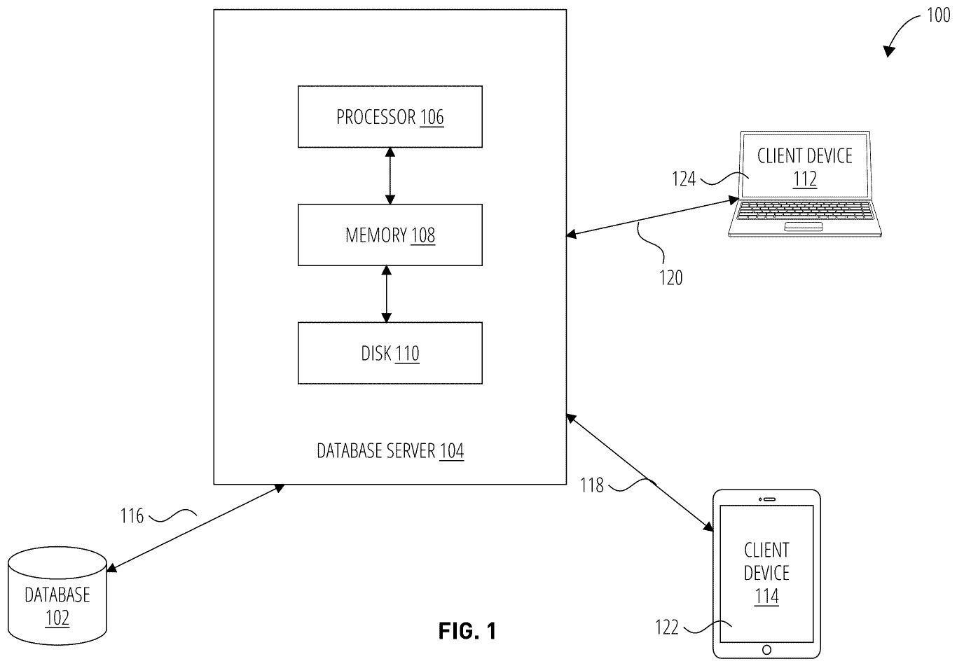

FIG. 1 illustrates an example of a system 100 for a visual display of overlapping timeline intervals.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

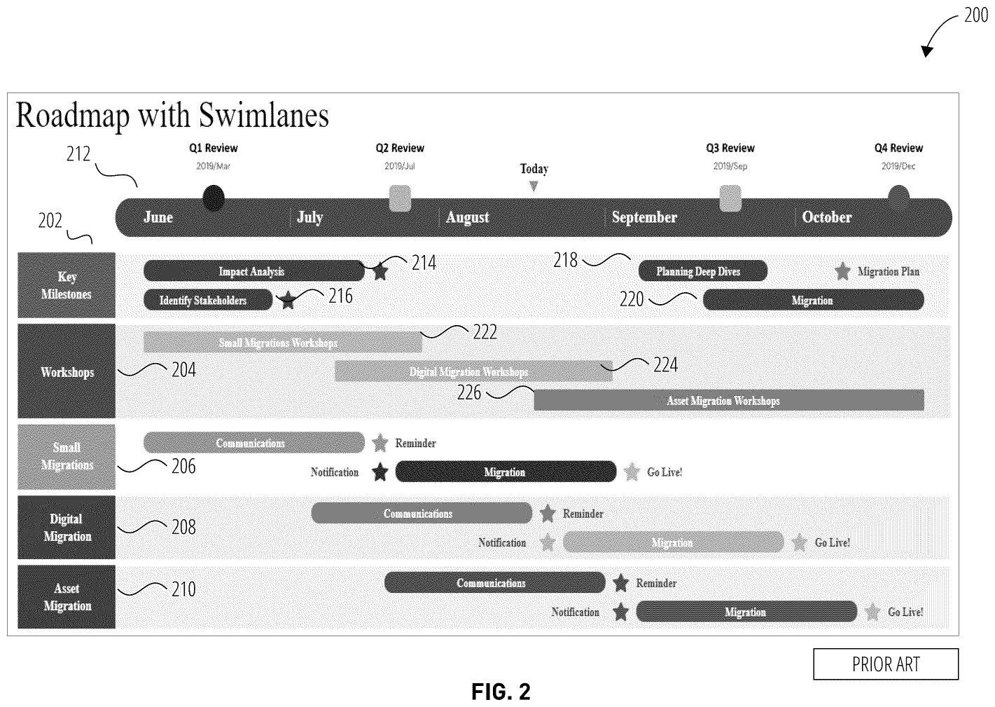

FIG. 2 illustrates a roadmap with conventional swimlanes 200, which includes five swimlanes (Key Milestones 202, Workshops 204, Small Migrations 206, Digital Migrations 208 and Asset Migration 210) and a timeline 212 (from June through October).

In the swimlane Key Milestones 202, there are four entries: Impact Analysis 214, Identify Stakeholders 216, Planning Deep Dives 218 and Migration 220. Impact Analysis 214 and Identify Stakeholders 216 overlap in terms of timeline 212. However, Identify Stakeholders 216 is placed on a different line from Impact Analysis 214, because of the overlap. Similarly, Planning Deep Dives 218 and Migration 220 also overlap; Migration 220 is placed on a different line than Planning Deep Dives 218 due to the overlap. Note that Impact Analysis 214 and Planning Deep Dives 218 are placed on the same line, since these two items do not overlap. Similarly, Identify Stakeholders 216 and Migration 220 are also placed on the same line, since these two do not overlap. It is conceivable that other items that are to be added in the swimlane Key Milestones 202, may also need to be added in separate lines, if the item overlaps with any of the other items in the swimlane. This can make the swimlane larger, in terms of length and/or height.

In the swimlane Workshops 204, there are three entries: Small Migration Workshops 222, Digital Migration Workshops 224 and Asset Migration Workshops 226. There is an overlap between Small Migration Workshops 222 and Digital Migration Workshops 224. Furthermore, there is an overlap between Digital Migration Workshops 224 and Asset Migration Workshops 226. All three items, Small Migration Workshops 222, Digital Migration Workshops 224 and Asset Migration Workshops 226 are thus placed on three different lines in the swimlane, due to the overlap. Other items that are to be added in the swimlane Workshops 204, will also need to be added in separate lines, as the item will overlap with items 222-224. This can make the swimlane larger, in terms of length.

The remaining swimlanes (Small Migrations 206, Digital Migrations 208 and 210) each have two items that do not overlap. Within each of these swimlanes, the two items have been placed on separate lines, although each item can be placed on a single line. Nonetheless, if these is an addition of one or more new items onto either one of these swimlanes (206, 208, 210), it is possible that the new item will be introduced in a line if the new item overlaps with any of the pre-existing items-thus making the swimlane larger, in terms of length.

Therefore, swimlanes can become unwieldy and large, as more items are added to each swimlane. There is thus a need to make the overall chart more compact.

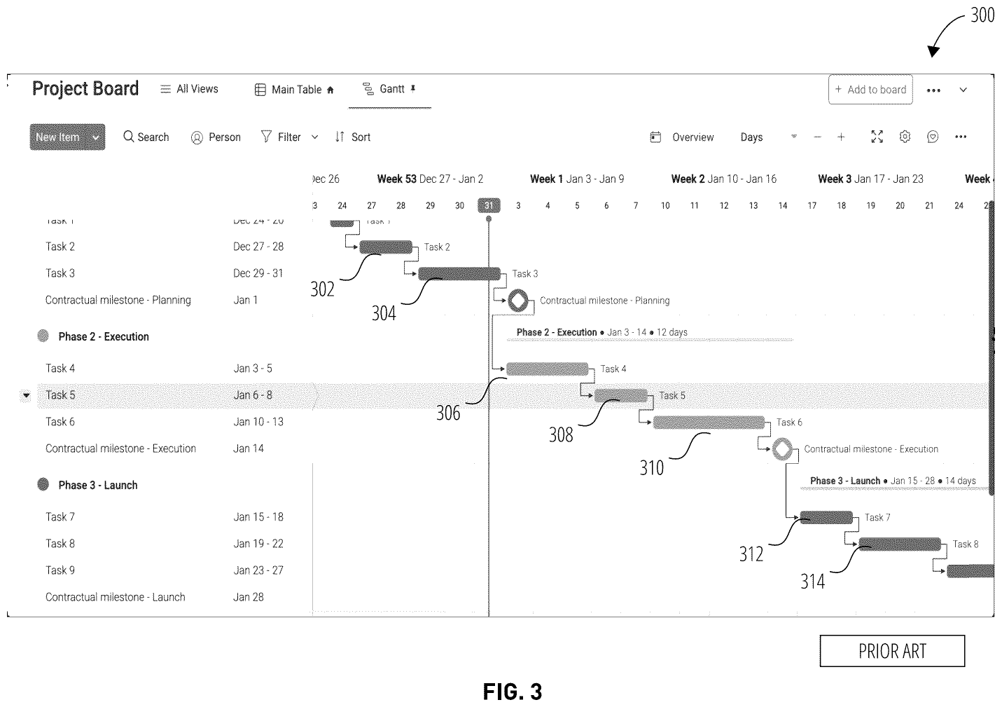

FIG. 3 illustrates a conventional Gantt chart 300, which is large since timelines need to be clear by placing each timeline on a separate line. Thus, Task 2 302-Task 8 314, which follow sequentially, are each placed on a separate line. On the other hand, a conventional Gantt chart would be unreadable if the timelines were allowed to overlap. Nonetheless, there is thus a need to make the overall chart more compact.

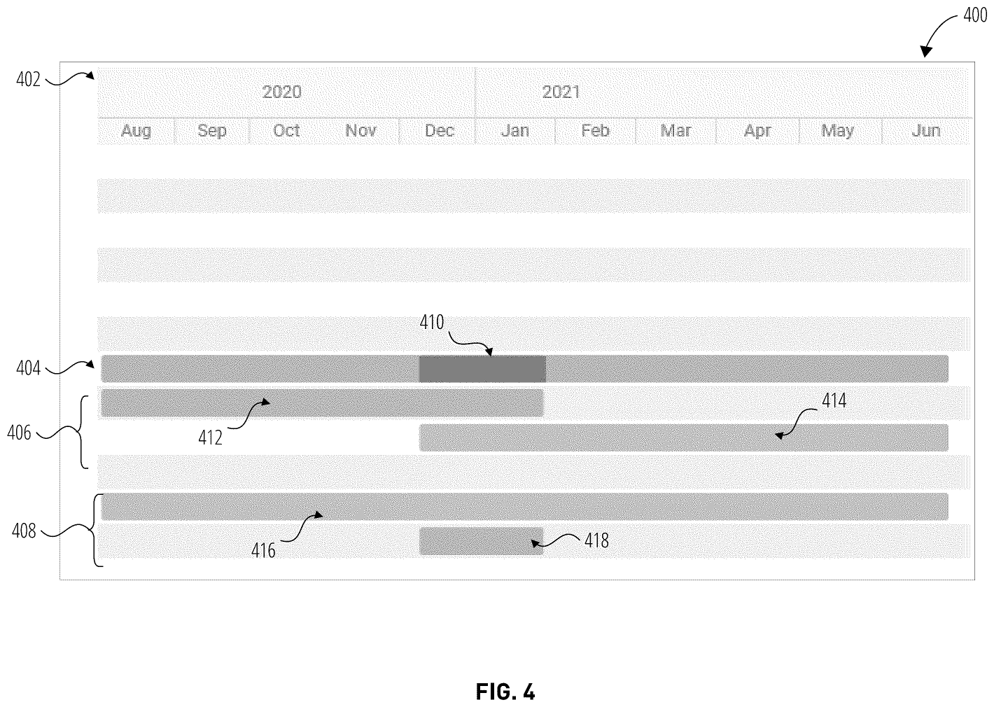

FIG. 4 illustrates a conventional example 400 of overlapping timelines. In this example, a calendar 402 shows the monthly period between August 2020 and June 2021. During this period, a conventional visual display 404 associated with the calendar, shows two overlapping events extending between August 2020 and June 2021. The events are overlapping because of the darkened block 410 that extends from December 2020 through January 2021.

However, the beginning and end date of each event is not clear from the visual display 404. It may be represented by the two events shown at 406: a first event 412 extending from August 2020 through January 2021, and a second event 414 extending from December 2020 through June 2021. This results in the overlap block 410.

Alternatively, it may be represented by the two events shown at 408: a first event 416 extending from August 2020 through June 2021, and a second event 418 extending from December 2020 through January 2021. This also results in the overlap block 410.

Therefore, conventional visual displays of overlapping events result in uncertainty regarding the respective timelines of the individual events that overlap.

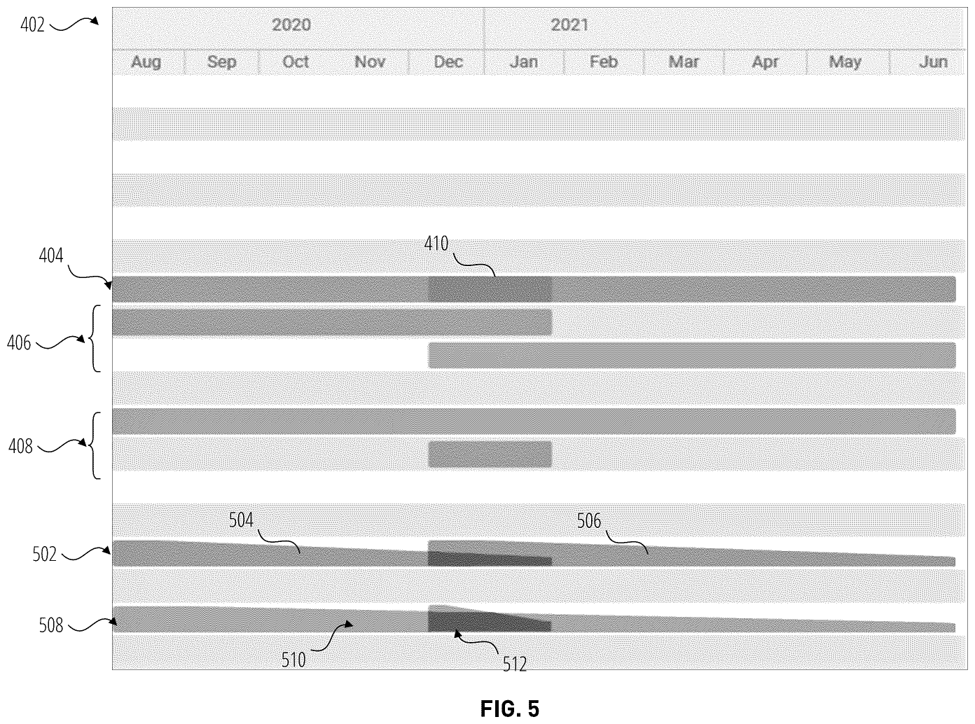

FIG. 5 illustrates an aspect of the subject matter in accordance with one embodiment. The calendar 402 of FIG. 4 is reproduced, as are conventional visual display 404, and the two possible timelines 406 and 408 that can give rise to visual display 404. As stated with respect to FIG. 4, the conventional display 404 gives rise to uncertainty.

Visual display 502, on the other hand, which is an embodiment, employs directional shapes to represent each timeline of events. A directional shape is asymmetrical with respect to the chronological direction. In the embodiment shown in FIG. 5, the directional shape tapers in a future direction. A first event 504 (with a timeline from August 2020 through January 2021) is represented using a directional shape, and is clearly marked from second event 506 (with a timeline from December 2020 through June 2021). This is in contrast to using the conventional representation of timelines shown in 406, which gives rise to the confusing overlapping of timelines represented by display 404.

Similarly, visual display 508 employs directional shapes to represent each timeline of events. Here, a first event 510 (with a timeline from August 2020 through June 2021) is represented using a directional shape, and is clearly marked from second event 512 (with a timeline from December 2020 through January 2021). This is in contrast to using the conventional representation of timelines shown in 408, which gives rise to the confusing overlapping of timelines represented by display 404.

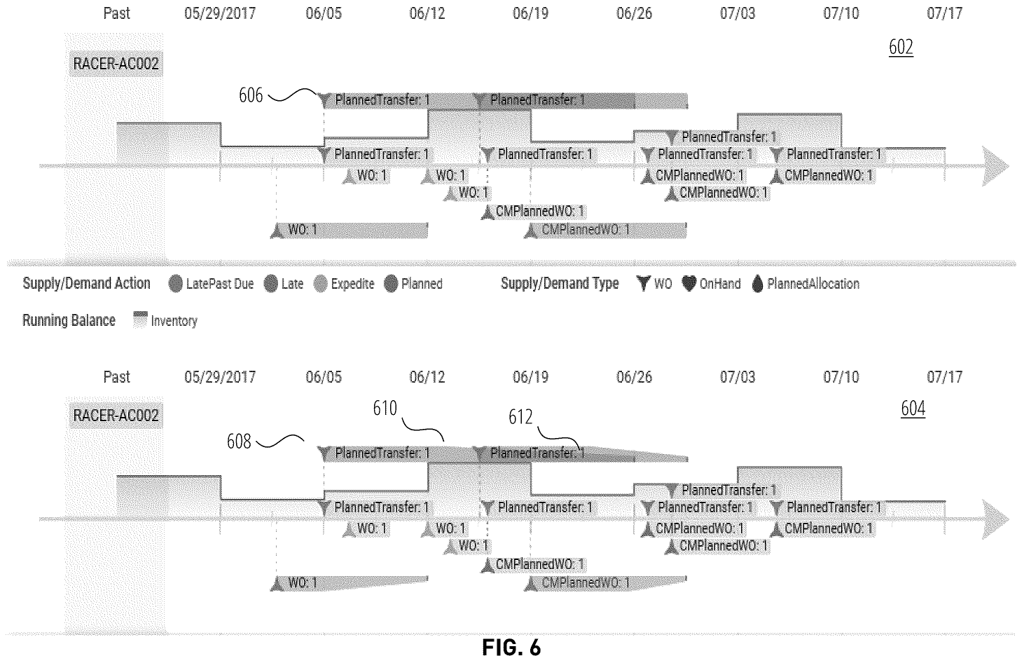

FIG. 6 illustrates an aspect of the subject matter in accordance with one embodiment. A complex planning chart is shown, using a conventional display 602, and a display 604 in which directional shapes are used for overlapping timelines.

In conventional display 602, the overlapping timeline 606 of two planned transfers gives rise to uncertainty regarding the individual timelines of each planned transfer. Is a first planned transfer scheduled from June 5 to June 30, and the second planned transfer scheduled from June 15 to June 26? Or is a first planned transfer scheduled from June 5 to June 26, and the second planned transfer scheduled from June 15 to June 30? The conventional display 602 results in confusion of planned transfers.

However, in display 604, the overlapping timeline 608 of two planned transfers uses directional shapes for each timeline. It is clear that a first planned transfer 610 is scheduled from June 5 to June 30, while the second planned transfer 612 is scheduled from June 15 to June 26.

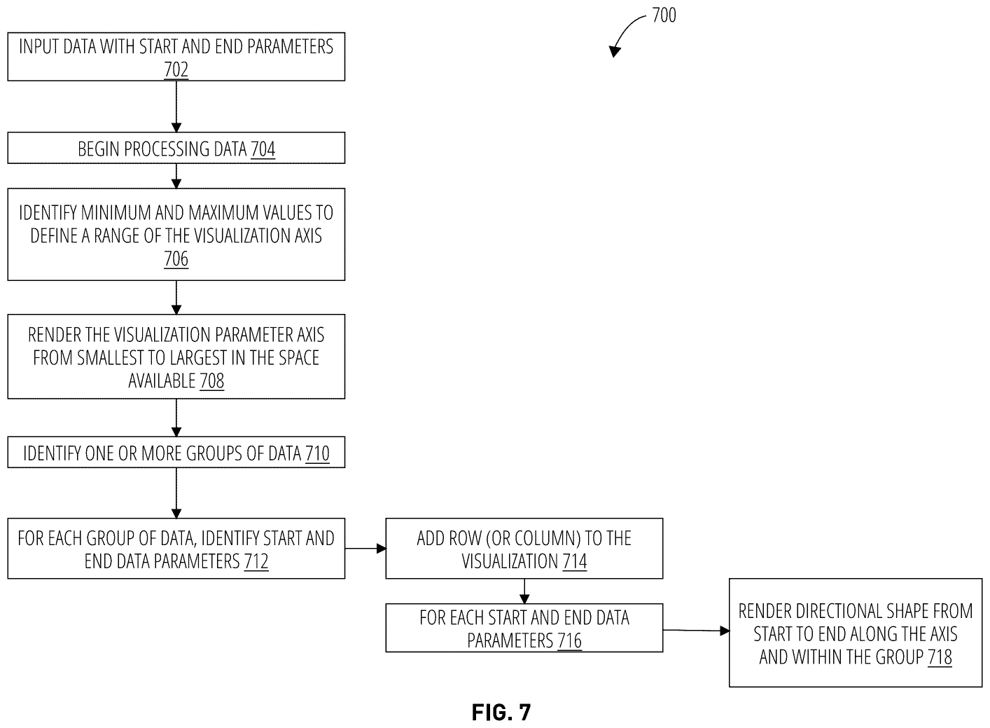

FIG. 7 illustrates a block diagram 700 in accordance with one embodiment.

At block 702, data is input; the data includes start and end parameters. The input data can be ordered-for example, ordered according to date, to time, to date time, to numbers, to integers, and so forth. Note, however, that the order of the input data is not a requirement as the directional translucent shape rendering can be done in any order.

In addition, the data can also include any data for which there is a continuous axis. For example, one may use an axis which represents the alphabet letters A-Z and the input data may include a starting and ending letter. This, and other types of input data can be supported.

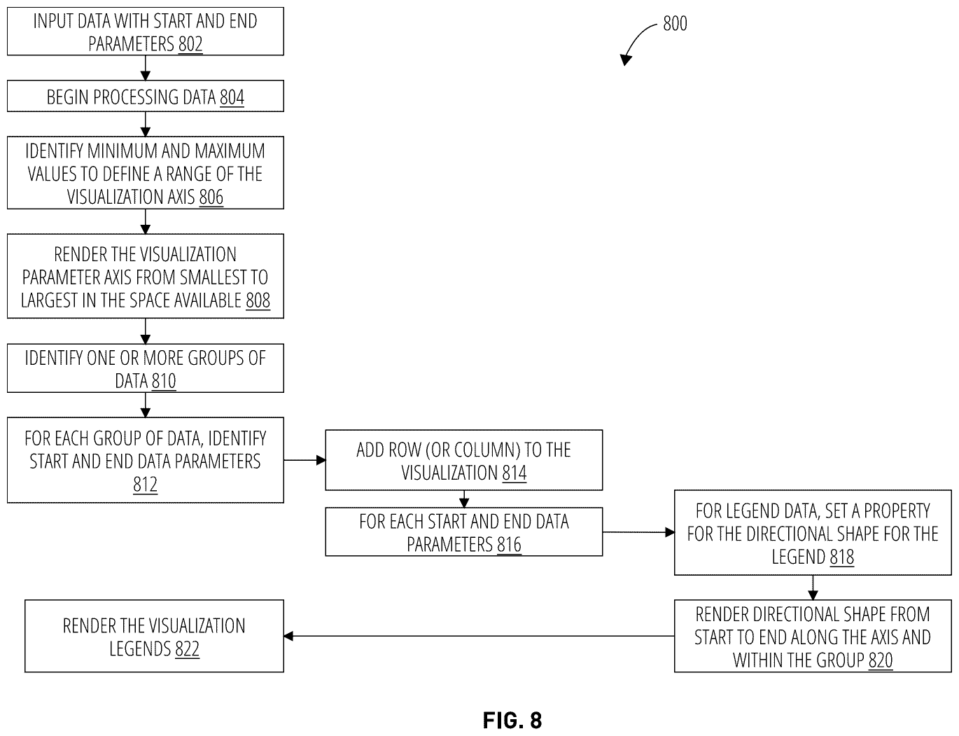

The data can also include a parameter used to group sets of start and end parameters. The data can also include one or more parameters used to define one or more elements in a legend-this case is discussed in FIG. 8.

At block 704, processing of the data begins. Next, at block 706, minimum and maximum values that define a range of the visualization axis, can be identified. For example, these can be the smallest start, and largest end, parameter values. Note it is also possible to compute the start and end values for the visualization parameter axis by looking through the input data and finding the minimum and maximum values to determine the range.

At block 708, the visualization parameter axis can be rendered from the smallest to the largest, in the space available. For example, this can include the smallest start and largest end parameter values. Next, at block 710, groups of data can be identified. For each group of data, start and end data parameters can be identified at block 712. For each group of data, a row (or a column) may be added to the visualization at block 714. Then, for each start and end parameters (block 716), a directional shape may be rendered from start to end along the axis and within the group at block 718. The directional shapes show the start and end dates when rendered on top of other directional shapes—as such, the directional shapes can be translucent. As an example, the directional shapes can use alpha transparency.

FIG. 8 illustrates a block diagram 800 in accordance with one embodiment.

At block 802, data is input; the data includes start and end parameters. The input data can be ordered—for example, ordered according to date, to time, to date time, to numbers, to integers, and so forth. Note, however, that the order of the input data is not a requirement as the directional translucent shape rendering can be done in any order.

The data can also include a parameter used to group sets of start and end parameters. The data can also include one or more parameters used to define one or more elements in a legend.

At block 804, processing of the data begins. Next, at block 806, minimum and maximum values that define a range of the visualization axis, can be identified. For example, these can be the smallest start, and largest end, parameter values. Note it is also possible to compute the start and end values for the visualization parameter axis by looking through the input data and finding the minimum and maximum values to determine the range.

At block 808, the visualization parameter axis may be rendered from the smallest to the largest, in the space available. For example, this can include the smallest start and largest end parameter values. Next, at block 810, groups of data can be identified. For each group of data, start and end data parameters may be identified at block 812. For each group of data, a row (or a column) may be added to the visualization at block 814.

Then, for each start and end parameters (block 816), a property for the directional shape for the legend can be set at block 818. For example, the property can include colour. Next, at block 820, a directional shape may be rendered from start to end along the axis and within the group. The directional shapes show the start and end dates when rendered on top of other directional shapes—as such, the directional shapes can be translucent. As an example, the directional shapes can use alpha transparency. Finally, at block 822, the visualization legends are rendered.

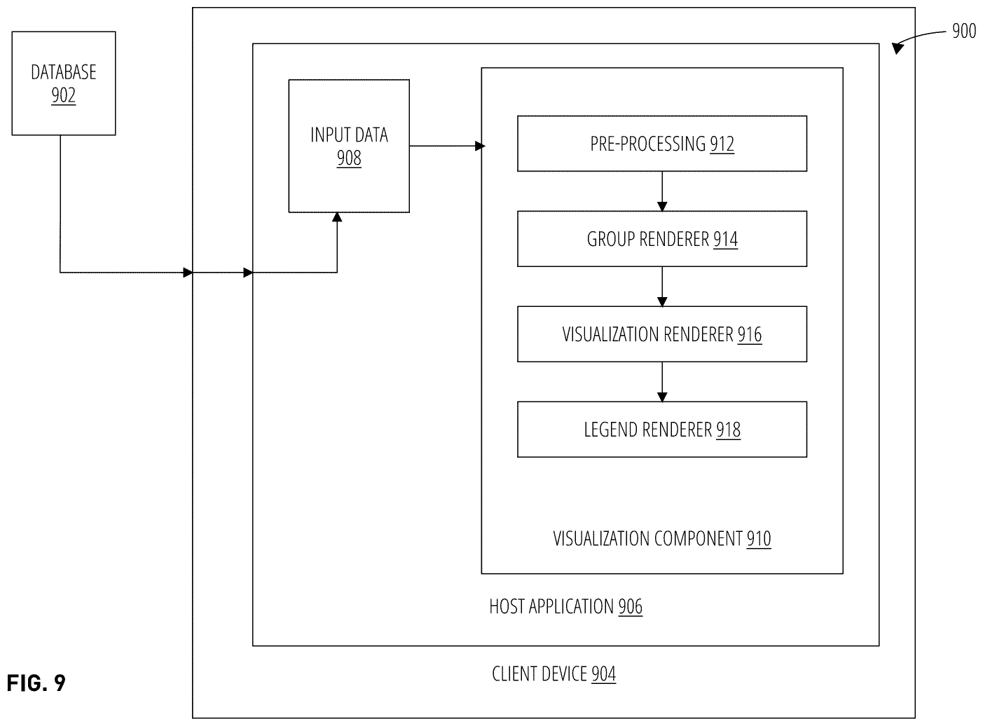

FIG. 9 illustrates a system architecture diagram 900 in accordance with one embodiment.

Data can be retrieved from database 902. It should be noted that the data source can include a database server and/or an application server. The data can be received by the host application 906, which may be on the client device 904, at input data 908. The data that is received at input data 908, can then be sent to various stages in visualization component 910, which are described below.

The data that is received at input data 908, can then be pre-processed at 912. Pre-processing can include data preparation, determining layout of the visualization, determining layout style, finding axis boundaries, and the like.

Once the data is pre-processed at 912, a group renderer 914 can render each group of the visualization as rows or columns. If no groups are defined, then a default group can be created. Next, a visualization renderer 916 can render the visual elements of the visualization. Finally, if the data contains data related to a legend, legend renderer 918 can render a visualization legend.

The visualization can be rendered on a client device, or using server side rendering or other type of processing that can create a visualization.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown. or sequential order, to achieve desirable results. In certain implementations. multitasking and parallel processing may be advantageous.

1. A computer-implemented method, comprising:
receiving, by a processor, input data having one or more start parameters and one or more end parameters;
identifying, by the processor, a minimum value and a maximum value to define a range of a visualization axis;
rendering, by the processor, a visualization parameter axis from a smallest parameter to a largest parameter;
identifying, by the processor, one or more groups of data;
for each group of data:
identifying, by the processor, a set of start data parameters and a set of end data parameters;
adding, by the processor, a row or a column to a visualization; and
for each start data parameter and each end data parameter:
rendering, by the processor, a directional shape from start to end along the visualization parameter axis, the directional shape being translucent.

2. The computer-implemented method of claim 1, wherein the input data is ordered.

3. The computer-implemented method of claim 2, wherein the input data is one of a date, a time, a date time, a number, or an integer.

4. The computer-implemented method of claim 1, wherein the input data comprises a parameter for grouping one or more sets of start parameters and end parameters.

5. The computer-implemented method of claim 1, wherein the minimum value is equal to a smallest start parameter value, and the maximum value is equal to a largest end parameter value.

6. The computer-implemented method of claim 1, wherein the method is for a visual display of overlapping timeline intervals, and the method comprises:
visually displaying, by the processor, one or more overlapping events, wherein a timeline of each event is displayed with a respective directional shape.

7. A computing apparatus comprising:
a processor; and
a memory storing instructions that, when executed by the processor, configure the apparatus to:
receive input data having one or more start parameters and one or more end parameters;
identify a minimum value and a maximum value to define a range of a visualization axis;
render a visualization parameter axis from a smallest parameter to a largest parameter;
identify one or more groups of data;
for each group of data:
identify a set of start data parameters and a set of end data parameters;
add a row or a column to a visualization; and
for each start data parameter and each end data parameter:
render a directional shape from start to end along the visualization parameter axis, the directional shape being translucent.

8. The computing apparatus of claim 7, wherein the input data is ordered.

9. The computing apparatus of claim 8, wherein the input data is one of a date, a time, a date time, a number, or an integer.

10. The computing apparatus of claim 7, wherein the input data comprises a parameter for grouping one or more sets of start parameters and end parameters.

11. The computing apparatus of claim 7, wherein the minimum value is equal to a smallest start parameter value, and the maximum value is equal to a largest end parameter value.

12. The computing apparatus of claim 7, wherein the computing apparatus provides a visual display of overlapping timeline intervals, and the instructions that, when executed by the processor, configure the apparatus to:
visually display one or more overlapping events, wherein a timeline of each event is displayed with a respective directional shape.

13. A non-transitory computer-readable storage medium, the computer-readable storage medium including instructions that when executed by a computer, cause the computer to:
receive input data having one or more start parameters and one or more end parameters;
identify a minimum value and a maximum value to define a range of a visualization axis;
render a visualization parameter axis from a smallest parameter to a largest parameter;
identify one or more groups of data;
for each group of data:
identify by the processor, a set of start data parameters and a set of end data parameters;
add a row or a column to a visualization; and
for each start data parameter and each end data parameter:
render a directional shape from start to end along the visualization parameter axis, the directional shape being translucent.

14. The computer-readable storage medium of claim 13, wherein the input data is ordered.

15. The computer-readable storage medium of claim 14, wherein the input data is one of a date, a time, a date time, a number, or an integer.

16. The computer-readable storage medium of claim 13, wherein the input data comprises a parameter for grouping one or more sets of start parameters and end parameters.

17. The computer-readable storage medium of claim 13, wherein the minimum value is equal to a smallest start parameter value, and the maximum value is equal to a largest end parameter value.

18. The computer-readable storage medium of claim 13, wherein the computer-readable storage medium provides a visual display of overlapping timeline intervals, and the instructions that when executed by a computer, cause the computer to:
visually display one or more overlapping events, wherein a timeline of each event is displayed with a respective directional shape.
